(19) United States
(12) Patent Application Publication
(10) Pub. No.: US 2022/0050971 A1
(43) Pub. Date: Feb. 17, 2022

(54) System and Method for Generating Responses for Conversational Agents

(71) Applicant: Nuance Communications, Inc., Burlington, MA (US)

(72) Inventors: Ding Liu, Lexington, MA (US); Paul Joseph Vozila, Arlington, MA (US); Peter Stubley, Beaconsfield (CA); Aaron Joseph Dunlop, Newberg, OR (US); Zhiping Fu, Billerica, MA (US); Giovanni Bonetta, Belluno (IT)

(21) Appl. No.: 16/990,014

(22) Filed: Aug. 11, 2020

(51) Int. Cl. G06F 40/35; H04L 12/58; G06F 40/289; G06N 20/00; G06N 5/04

(52) U.S. Cl. CPC G06F 40/35; H04L 51/02; G06N 5/04; G06N 20/00; G06F 40/289

(57) ABSTRACT

A method, computer program product, and computer system for predicting responses to at least one conversational phrase. At least one conversational phrase may be received. A first probability for a subset of candidate responses of a plurality of candidate responses may be determined based upon, at least in part, context associated with the at least one conversational phrase, the at least one conversational phrase, and each context associated with the plurality of candidate responses. A second probability for the subset of candidate responses may be determined based upon, at least in part, the subset of candidate responses, the at least one conversational phrase, and the context associated with the at least one conversational phrase. At least one candidate response for the at least one conversational phrase may be determined based upon, at least in part, the first probability and the second probability.

### BACKGROUND

The creation of conversational agents often requires developers to review and annotate large amounts of conversation history. For example, the conventional process of determining a response to a conversational phrase may require processing numerous chat logs or transcripts by manually labeling intents, mentions, and/or dialogue states. As such, the development of conversational agents may be limited by the process of manually annotating chat logs or transcripts. Further, the computing resources required for and accuracy of conventional processes for determining a response to a conversational phrase may be limited by the ability to train models with annotated data.

### BRIEF SUMMARY OF DISCLOSURE

In one example implementation, a method, performed by one or more computing devices, may include but is not limited to receiving at least one conversational phrase. A first probability for a subset of candidate responses of a plurality of candidate responses may be determined based upon, at least in part, context associated with the at least one conversational phrase, the at least one conversational phrase, and each context associated with the plurality of candidate responses. A second probability for the subset of candidate responses may be determined based upon, at least in part, the subset of candidate responses, the at least one conversational phrase, and the context associated with the at least one conversational phrase. At least one candidate response for the conversational phrase may be determined based upon, at least in part, the first probability for the subset of candidate responses and the second probability for the subset of candidate responses.

One or more of the following example features may be included. The subset of candidate responses of the plurality of candidate responses may include a predefined number of nearest neighbor context-response pairs of a plurality of context-responses pairs observed in system training. The first probability may define a likelihood of the subset of candidate responses as candidate responses to the at least one conversational phrase based upon, at least in part, a distance between the context of the at least one conversational phrase and the at least one conversational phrase, and the context associated with each context-response pair observed in system training. The second probability may define a likelihood of the subset of candidate responses as candidate responses to the at least one conversational phrase based upon, at least in part, a distance between the context of the conversational phrase and the at least one conversational phrase, and the response associated with each context-response pair of the subset of candidate responses. Determining the at least one candidate response to the at least one conversational phrase based upon, at least in part, the first probability for the subset of candidate responses and the second probability for the subset of candidate responses may include interpolating the first probability for the subset of candidate responses and the second probability for the subset of candidate responses. A first model configured to determine the first probability for the subset of candidate responses and a second model configured to determine the second probability for the subset of candidate responses may be concurrently trained together. The first model and the second model may be sequentially trained. The first model and the second model may be trained in parallel. Concurrently training the first model and the second model together may include one or more of: updating a predefined number of nearest neighbor context-response pairs via a separate computing device and sharing at least one encoder between the first model and the second model.

In another example implementation, a computing system may include one or more processors and one or more memories configured to perform operations that may include but are not limited to receiving at least one conversational phrase. A first probability for a subset of candidate responses of a plurality of candidate responses may be determined based upon, at least in part, context associated with the at least one conversational phrase, the at least one conversational phrase, and each context associated with the plurality of candidate responses. A second probability for the subset of candidate responses may be determined based upon, at least in part, the subset of candidate responses, the at least one conversational phrase, and the context associated with the at least one conversational phrase. At least one candidate response for the at least one conversational phrase may be determined based upon, at least in part, the first probability for the subset of candidate responses and the second probability for the subset of candidate responses.

One or more of the following example features may be included. The subset of candidate responses of the plurality of candidate responses may include a predefined number of nearest neighbor context-response pairs of a plurality of context-responses pairs observed in system training. The first probability may define a likelihood of the subset of candidate responses as candidate responses to the at least one conversational phrase based upon, at least in part, a distance between the context of the at least one conversational phrase and the at least one conversational phrase, and the context associated with each context-response pair observed in system training. The second probability may define a likelihood of the subset of candidate responses as candidate responses to the at least one conversational phrase based upon, at least in part, a distance between the context of the at least one conversational phrase and the at least one conversational phrase, and the response associated with each context-response pair of the subset of candidate responses. Determining the at least one candidate response to the at least one conversational phrase based upon, at least in part, the first probability for the subset of candidate responses and the second probability for the subset of candidate responses may include interpolating the first probability for the subset of candidate responses and the second probability for the subset of candidate responses. A first model configured to determine the first probability for the subset of candidate responses and a second model configured to determine the second probability for the subset of candidate responses may be concurrently trained together. The first model and the second model may be sequentially trained. The first model and the second model may be trained in parallel. Concurrently training the first model and the second model together may include one or more of: updating a predefined number of nearest neighbor context-response pairs via a separate computing device and sharing at least one encoder between the first model and the second model.

In another example implementation, a computer program product may reside on a computer readable storage medium having a plurality of instructions stored thereon which, when executed across one or more processors, may cause at least a portion of the one or more processors to perform operations that may include but are not limited to receiving at least one conversational phrase. At least a portion of the one or more processors may be configured to determine a first probability for a subset of candidate responses of a plurality of candidate responses based upon, at least in part, context associated with the at least one conversational phrase, the at least one conversational phrase, and each context associated with the plurality of candidate responses. At least a portion of the one or more processors may be configured to determine a second probability for the subset of candidate responses based upon, at least in part, the subset of candidate responses, the at least one conversational phrase, and the context associated with the at least one conversational phrase. At least a portion of the one or more processors may be configured to determine at least one candidate response for the at least one conversational phrase based upon, at least in part, the first probability for the subset of candidate responses and the second probability for the subset of candidate responses.

One or more of the following example features may be included. The subset of candidate responses of the plurality of candidate responses may include a predefined number of nearest neighbor context-response pairs of a plurality of context-responses pairs observed in system training. The first probability may define a likelihood of the subset of candidate responses as candidate responses to the at least one conversational phrase based upon, at least in part, a distance between the context of the at least one conversational phrase and the at least one conversational phrase, and the context associated with each context-response pair observed in system training. The second probability may define a likelihood of the subset of candidate responses as candidate responses to the at least one conversational phrase based upon, at least in part, a distance between the context of the at least one conversational phrase and the at least one conversational phrase, and the response associated with each context-response pair of the subset of candidate responses. Determining the at least one candidate response to the at least one conversational phrase based upon, at least in part, the first probability for the subset of candidate responses and the second probability for the subset of candidate responses may include interpolating the first probability for the subset of candidate responses and the second probability for the subset of candidate responses. A first model configured to determine the first probability for the subset of candidate responses and a second model configured to determine the second probability for the subset of candidate responses may be concurrently trained together. The first model and the second model may be sequentially trained. The first model and the second model may be trained in parallel. Concurrently training the first model and the second model together may include one or more of: updating a predefined number of nearest neighbor context-response pairs via a separate computing device and sharing at least one encoder between the first model and the second model.

The details of one or more example implementations are set forth in the accompanying drawings and the description below. Other possible example features and/or possible example advantages will become apparent from the description, the drawings, and the claims. Some implementations may not have those possible example features and/or possible example advantages, and such possible example features and/or possible example advantages may not necessarily be required of some implementations.

### BRIEF DESCRIPTION OF THE DRAWINGS

FIG. 1 is an example diagrammatic view of a prediction process coupled to an example distributed computing network according to one or more example implementations of the disclosure;

FIG. 2 is an example diagrammatic view of a computer and client electronic device of FIG. 1 according to one or more example implementations of the disclosure;

FIG. 3 is an example flowchart of a prediction process according to one or more example implementations of the disclosure;

FIG. 4 is an example diagrammatic view of prediction process according to one or more example implementations of the disclosure; and

FIG. 5 is an example diagrammatic view of a conversation database utilized by a prediction process according to one or more example implementations of the disclosure;

FIG. 6 is an example diagrammatic view of aspects of a prediction process according to one or more example implementations of the disclosure;

FIG. 7 is an example diagrammatic view of providing at least one candidate response by prediction process according to one or more example implementations of the disclosure.

Like reference symbols in the various drawings indicate like elements.

### DETAILED DESCRIPTION

### System Overview:

In some implementations, the present disclosure may be embodied as a method, system, or computer program product. Accordingly, in some implementations, the present disclosure may take the form of an entirely hardware implementation, an entirely software implementation (including firmware, resident software, micro-code, etc.) or an implementation combining software and hardware aspects that may all generally be referred to herein as a “circuit,” “module” or “system.” Furthermore, in some implementations, the present disclosure may take the form of a computer program product on a computer-usable storage medium having computer-usable program code embodied in the medium.

In some implementations, any suitable computer usable or computer readable medium (or media) may be utilized. The computer readable medium may be a computer readable signal medium or a computer readable storage medium. The computer-usable, or computer-readable, storage medium (including a storage device associated with a computing device or client electronic device) may be, for example, but is not limited to, an electronic, magnetic, optical, electromagnetic, infrared, or semiconductor system, apparatus, device, or any suitable combination of the foregoing. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a digital versatile disk (DVD), a static random access memory (SRAM), a memory stick, a floppy disk, a mechanically encoded device such as punch-cards or raised structures in a groove having instructions recorded thereon, a media such as those supporting the internet or an intranet, or a magnetic storage device. Note that the computer-usable or computer-readable medium could even be a suitable medium upon which the program is stored, scanned, compiled, interpreted, or otherwise processed in a suitable manner, if necessary, and then stored in a computer memory. In the context of the present disclosure, a computer-usable or computer-readable, storage medium may be any tangible medium that can contain or store a program for use by or in connection with the instruction execution system, apparatus, or device.

In some implementations, a computer readable signal medium may include a propagated data signal with computer readable program code embodied therein, for example, in baseband or as part of a carrier wave. In some implementations, such a propagated signal may take any of a variety of forms, including, but not limited to, electro-magnetic, optical, or any suitable combination thereof. In some implementations, the computer readable program code may be transmitted using any appropriate medium, including but not limited to the internet, wireline, optical fiber cable, RF, etc. In some implementations, a computer readable signal medium may be any computer readable medium that is not a computer readable storage medium and that can communicate, propagate, or transport a program for use by or in connection with an instruction execution system, apparatus, or device.

In some implementations, computer program code for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java®, Smalltalk, C++ or the like. Java® and all Java-based trademarks and logos are trademarks or registered trademarks of Oracle and/or its affiliates. However, the computer program code for carrying out operations of the present disclosure may also be written in conventional procedural programming languages, such as the “C” programming language, PASCAL, or similar programming languages, as well as in scripting languages such as Javascript, PERL, or Python. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the internet using an Internet Service Provider). In some implementations, electronic circuitry including, for example, programmable logic circuitry, field-programmable gate arrays (FPGAs) or other hardware accelerators, micro-controller units (MCUs), or programmable logic arrays (PLAs) may execute the computer readable program instructions/code by utilizing state information of the computer readable program instructions to personalize the electronic circuitry, in order to perform aspects of the present disclosure.

In some implementations, the flowchart and block diagrams in the figures illustrate the architecture, functionality, and operation of possible implementations of apparatus (systems), methods and computer program products according to various implementations of the present disclosure. Each block in the flowchart and/or block diagrams, and combinations of blocks in the flowchart and/or block diagrams, may represent a module, segment, or portion of code, which comprises one or more executable computer program instructions for implementing the specified logical function(s)/act(s). These computer program instructions may be provided to a processor of a general purpose computer, special purpose computer, or other programmable data processing apparatus to produce a machine, such that the computer program instructions, which may execute via the processor of the computer or other programmable data processing apparatus, create the ability to implement one or more of the functions/acts specified in the flowchart and/or block diagram block or blocks or combinations thereof. It should be noted that, in some implementations, the functions noted in the block(s) may occur out of the order noted in the figures (or combined or omitted). For example, two blocks shown in succession may, in fact, be executed substantially concurrently, or the blocks may sometimes be executed in the reverse order, depending upon the functionality involved.

In some implementations, these computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks or combinations thereof.

In some implementations, the computer program instructions may also be loaded onto a computer or other programmable data processing apparatus to cause a series of operational steps to be performed (not necessarily in a particular order) on the computer or other programmable apparatus to produce a computer implemented process such that the instructions which execute on the computer or other programmable apparatus provide steps for implementing the functions/acts (not necessarily in a particular order) specified in the flowchart and/or block diagram block or blocks or combinations thereof.

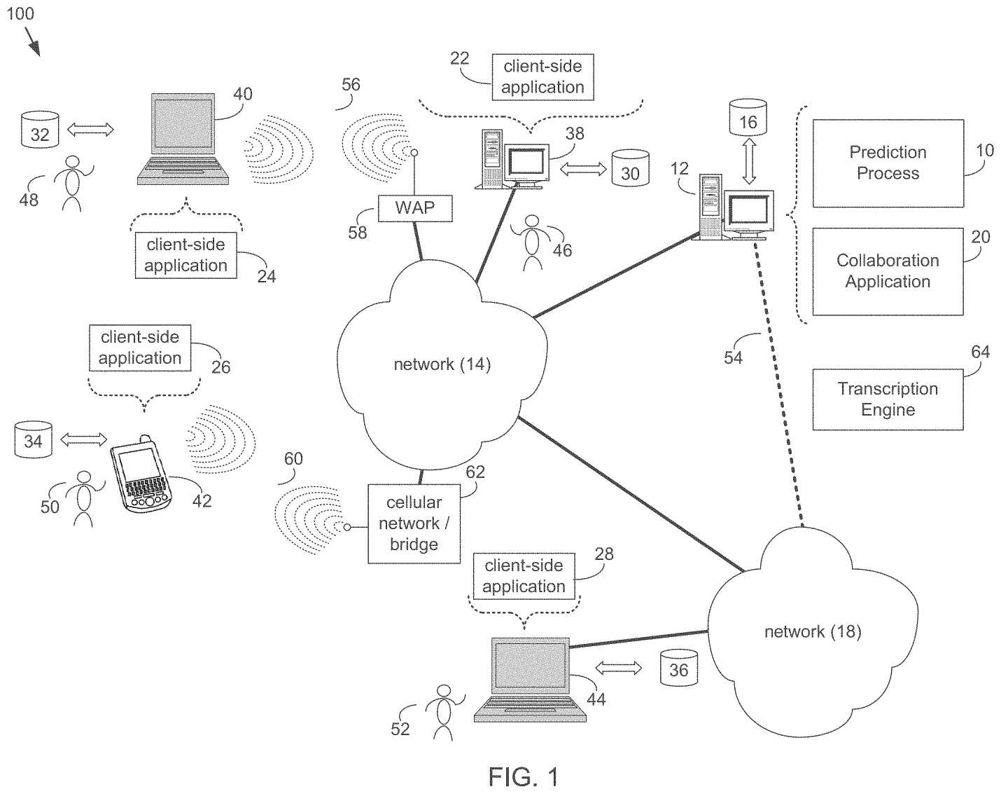

Referring now to the example implementation of FIG. 1, there is shown prediction process 10 that may reside on and may be executed by a computer (e.g., computer 12), which may be connected to a network (e.g., network 14) (e.g., the internet or a local area network). Examples of computer 12 (and/or one or more of the client electronic devices noted below) may include, but are not limited to, a storage system (e.g., a Network Attached Storage (NAS) system, a Storage Area Network (SAN)), a personal computer(s), a laptop computer(s), mobile computing device(s), a server computer, a series of server computers, a mainframe computer(s), or a computing cloud(s). As is known in the art, a SAN may include one or more of the client electronic devices, including a RAID device and a NAS system. In some implementations, each of the aforementioned may be generally described as a computing device. In certain implementations, a computing device may be a physical or virtual device. In many implementations, a computing device may be any device capable of performing operations, such as a dedicated processor, a portion of a processor, a virtual processor, a portion of a virtual processor, portion of a virtual device, or a virtual device. In some implementations, a processor may be a physical processor or a virtual processor. In some implementations, a virtual processor may correspond to one or more parts of one or more physical processors. In some implementations, the instructions/logic may be distributed and executed across one or more processors, virtual or physical, to execute the instructions/logic. Computer 12 may execute an operating system, for example, but not limited to, Microsoft® Windows®; Mac® OS X®; Red Hat® Linux®, Windows® Mobile, Chrome OS, Blackberry OS, Fire OS, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

In some implementations, as will be discussed below in greater detail, a prediction process, such as prediction process 10 of FIG. 1, may receive, by a computing device, at least one conversational phrase. A first probability for a subset of candidate responses of a plurality of candidate responses may be determined based upon, at least in part, context associated with the at least one conversational phrase, the at least one conversational phrase, and each context associated with the plurality of candidate responses. A second probability for the subset of candidate responses may be determined based upon, at least in part, the subset of candidate responses, the at least one conversational phrase, and the context associated with the at least one conversational phrase. At least one candidate response for the at least one conversational phrase may be determined based upon, at least in part, the first probability for the subset of candidate responses and the second probability for the subset of candidate responses.

In some implementations, the instruction sets and subroutines of prediction process 10, which may be stored on storage device, such as storage device 16, coupled to computer 12, may be executed by one or more processors and one or more memory architectures included within computer 12. In some implementations, storage device 16 may include but is not limited to: a hard disk drive; all forms of flash memory storage devices; a tape drive; an optical drive; a RAID array (or other array); a random access memory (RAM); a read-only memory (ROM); or combination thereof. In some implementations, storage device 16 may be organized as an extent, an extent pool, a RAID extent (e.g., an example 4D+1P R5, where the RAID extent may include, e.g., five storage device extents that may be allocated from, e.g., five different storage devices), a mapped RAID (e.g., a collection of RAID extents), or combination thereof.

In some implementations, network 14 may be connected to one or more secondary networks (e.g., network 18), examples of which may include but are not limited to: a local area network; a wide area network; or an intranet, for example.

In some implementations, computer 12 may include a data store, such as a database (e.g., relational database, object-oriented database, triplestore database, etc.) and may be located within any suitable memory location, such as storage device 16 coupled to computer 12. In some implementations, data, metadata, information, etc. described throughout the present disclosure may be stored in the data store. In some implementations, computer 12 may utilize any known database management system such as, but not limited to, DB2, in order to provide multi-user access to one or more databases, such as the above noted relational database. In some implementations, the data store may also be a custom database, such as, for example, a flat file database or an XML database. In some implementations, any other form(s) of a data storage structure and/or organization may also be used. In some implementations, prediction process 10 may be a component of the data store, a standalone application that interfaces with the above noted data store and/or an applet/application that is accessed via client applications 22, 24, 26, 28. In some implementations, the above noted data store may be, in whole or in part, distributed in a cloud computing topology. In this way, computer 12 and storage device 16 may refer to multiple devices, which may also be distributed throughout the network.

In some implementations, computer 12 may execute a collaboration application (e.g., collaboration application 20), examples of which may include, but are not limited to, e.g., a web conferencing application, a video conferencing application, a voice-over-IP application, a video-over-IP application, an Instant Messaging (IM)/“chat” application, an electronic mail (email) application, a search engine application, a short messaging service (SMS)/multimedia messaging service (MMS) application, or other application that allows for virtual meeting and/or remote collaboration.

In some implementations, prediction process 10 and/or collaboration application 20 may be accessed via one or more of client applications 22, 24, 26, 28. In some implementations, prediction process 10 may be a standalone application, or may be an applet/application/script/extension that may interact with and/or be executed within collaboration application 20, a component of collaboration application 20, and/or one or more of client applications 22, 24, 26, 28. In some implementations, collaboration application 20 may be a standalone application, or may be an applet/application/script/extension that may interact with and/or be executed within prediction process 10, a component of prediction process 10, and/or one or more of client applications 22, 24, 26, 28. In some implementations, one or more of client applications 22, 24, 26, 28 may be a standalone application, or may be an applet/application/script/extension that may interact with and/or be executed within and/or be a component of prediction process 10 and/or collaboration application 20. Examples of client applications 22, 24, 26, 28 may include, but are not limited to, e.g., a web conferencing application, a video conferencing application, a voice-over-IP application, a video-over-IP application, an Instant Messaging (IM)/“chat” application, an electronic mail (email) application, a search engine application, a short messaging service (SMS)/multimedia messaging service (MMS) application, or other application that allows for virtual meeting and/or remote collaboration, a standard and/or mobile web browser, an email application (e.g., an email client application), a textual and/or a graphical user interface, a customized web browser, a plugin, an Application Programming Interface (API), or a custom application. The instruction sets and subroutines of client applications 22, 24, 26, 28, which may be stored on storage devices 30, 32, 34, 36, coupled to client electronic devices 38, 40, 42, 44, may be executed by one or more processors and one or more memory architectures incorporated into client electronic devices 38, 40, 42, 44, may include but are not limited to: hard disk drives; flash drives, tape drives; optical drives; RAID arrays; random access memories (RAM); and read-only memories (ROM). Examples of client electronic devices 38, 40, 42, 44 (and/or computer 12) may include, but are not limited to, a personal computer (e.g., client electronic device 38), a laptop computer (e.g., client electronic device 40), a smart/data-enabled, cellular phone (e.g., client electronic device 42), a notebook computer (e.g., client electronic device 44), a tablet, a server, a television, a smart television, a media (e.g., video, photo, etc.) capturing device, and a dedicated network device. Client electronic devices 38, 40, 42, 44 may each execute an operating system, examples of which may include but are not limited to, Android™, Apple® iOS®, Mac® OS X®; Red Hat® Linux®, Windows® Mobile, Chrome OS, Blackberry OS, Fire OS, or a custom operating system.

In some implementations, one or more of client applications 22, 24, 26, 28 may be configured to effectuate some or all of the functionality of prediction process 10 (and vice versa). Accordingly, in some implementations, prediction process 10 may be a purely server-side application, a purely client-side application, or a hybrid server-side/client-side application that is cooperatively executed by one or more of client applications 22, 24, 26, 28 and/or prediction process 10.

In some implementations, one or more of client applications 22, 24, 26, 28 may be configured to effectuate some or all of the functionality of collaboration application 20 (and vice versa). Accordingly, in some implementations, collaboration application 20 may be a purely server-side application, a purely client-side application, or a hybrid server-side/client-side application that is cooperatively executed by one or more of client applications 22, 24, 26, 28 and/or collaboration application 20. As one or more of client applications 22, 24, 26, 28, prediction process 10, and collaboration application 20, taken singly or in any combination, may effectuate some or all of the same functionality, any description of effectuating such functionality via one or more of client applications 22, 24, 26, 28, prediction process 10, collaboration application 20, or combination thereof, and any described interaction(s) between one or more of client applications 22, 24, 26, 28, prediction process 10, collaboration application 20, or combination thereof to effectuate such functionality, should be taken as an example only and not to limit the scope of the disclosure.

In some implementations, one or more of users 46, 48, 50, 52 may access computer 12 and prediction process 10 (e.g., using one or more of client electronic devices 38, 40, 42, 44) directly through network 14 or through secondary network 18. Further, computer 12 may be connected to network 14 through secondary network 18, as illustrated with phantom link line 54. Prediction process 10 may include one or more user interfaces, such as browsers and textual or graphical user interfaces, through which users 46, 48, 50, 52 may access prediction process 10.

In some implementations, the various client electronic devices may be directly or indirectly coupled to network 14 (or network 18). For example, client electronic device 38 is shown directly coupled to network 14 via a hardwired network connection. Further, client electronic device 44 is shown directly coupled to network 18 via a hardwired network connection. Client electronic device 40 is shown wirelessly coupled to network 14 via wireless communication channel 56 established between client electronic device 40 and wireless access point (i.e., WAP) 58, which is shown directly coupled to network 14. WAP 58 may be, for example, an IEEE 802.11a, 802.11b, 802.11g, 802.11n, 802.11ac, Wi-Fi®, RFID, and/or Bluetooth™ (including Bluetooth™ Low Energy) device that is capable of establishing wireless communication channel 56 between client electronic device 40 and WAP 58. Client electronic device 42 is shown wirelessly coupled to network 14 via wireless communication channel 60 established between client electronic device 42 and cellular network/bridge 62, which is shown by example directly coupled to network 14.

In some implementations, some or all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. Bluetooth™ (including Bluetooth™ Low Energy) is a telecommunications industry specification that allows, e.g., mobile phones, computers, smart phones, and other electronic devices to be interconnected using a short-range wireless connection. Other forms of interconnection (e.g., Near Field Communication (NFC)) may also be used.

In some implementations, various I/O requests (e.g., I/O request 15) may be sent from, e.g., client applications 22, 24, 26, 28 to, e.g., computer 12. Examples of I/O request 15 may include but are not limited to, data write requests (e.g., a request that content be written to computer 12) and data read requests (e.g., a request that content be read from computer 12).

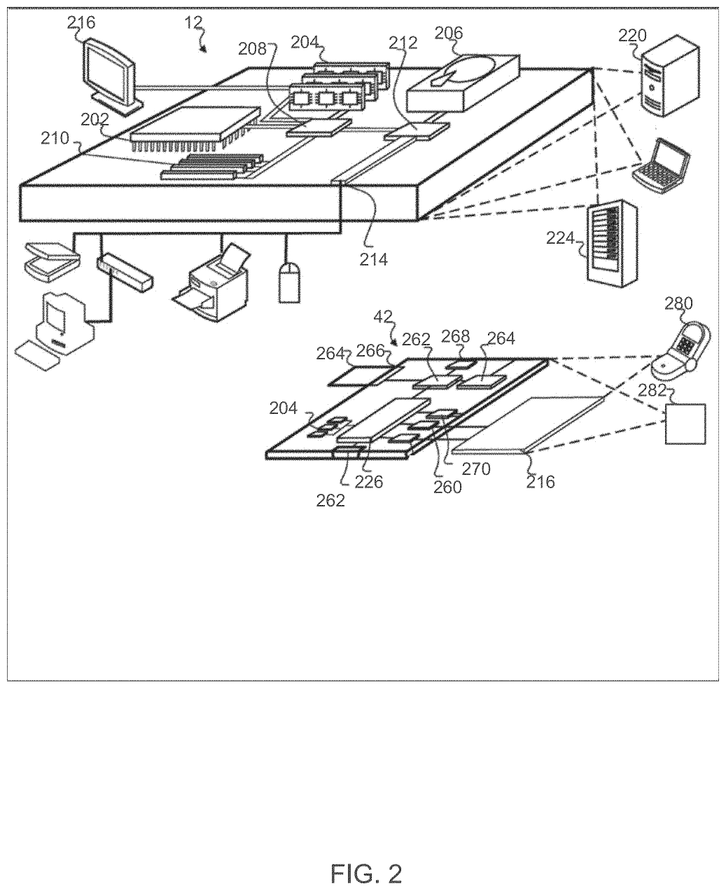

Referring also to the example implementation of FIG. 2, there is shown a diagrammatic view of computer 12 and client electronic device 42. While client electronic device 42 and computer 12 are shown in this figure, this is for example purposes only and is not intended to be a limitation of this disclosure, as other configurations are possible. Additionally, any computing device capable of executing, in whole or in part, prediction process 10 may be substituted for client electronic device 42 and computer 12 (in whole or in part) within FIG. 2, examples of which may include but are not limited to one or more of client electronic devices 38, 40, and 44. Client electronic device 42 and/or computer 12 may also include other devices, such as televisions with one or more processors embedded therein or attached thereto as well as any of the microphones, microphone arrays, and/or speakers described herein. The components shown here, their connections and relationships, and their functions, are meant to be examples only, and are not meant to limit implementations of the disclosure described.

In some implementations, computer 12 may include processor 202, memory 204, storage device 206, a high-speed interface 208 connecting to memory 204 and high-speed expansion ports 210, and low speed interface 212 connecting to low speed bus 214 and storage device 206. Each of the components 202, 204, 206, 208, 210, and 212, may be interconnected using various busses, and may be mounted on a common motherboard or in other manners as appropriate. The processor 202 can process instructions for execution within the computer 12, including instructions stored in the memory 204 or on the storage device 206 to display graphical information for a GUI on an external input/output device, such as display 216 coupled to high speed interface 208. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

Memory 204 may store information within the computer 12. In one implementation, memory 204 may be a volatile memory unit or units. In another implementation, memory 204 may be a non-volatile memory unit or units. The memory 204 may also be another form of computer-readable medium, such as a magnetic or optical disk.

Storage device 206 may be capable of providing mass storage for computer 12. In one implementation, the storage device 206 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 204, the storage device 206, memory on processor 202, or a propagated signal.

High speed controller 208 may manage bandwidth-intensive operations for computer 12, while the low speed controller 212 may manage lower bandwidth-intensive operations. Such allocation of functions is exemplary only. In one implementation, the high-speed controller 208 may be coupled to memory 204, display 216 (e.g., through a graphics processor or accelerator), and to high-speed expansion ports 210, which may accept various expansion cards (not shown). In the implementation, low-speed controller 212 is coupled to storage device 206 and low-speed expansion port 214. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

Computer 12 may be implemented in a number of different forms, as shown in the figure. For example, computer 12 may be implemented as a standard server 220, or multiple times in a group of such servers. It may also be implemented as part of a rack server system 224. Alternatively, components from computer 12 may be combined with other components in a mobile device (not shown), such as client electronic device 42. Each of such devices may contain one or more of computer 12, client electronic device 42, and an entire system may be made up of multiple computing devices communicating with each other.

Client electronic device 42 may include processor 226, memory 204, an input/output device such as display 216, a communication interface 262, and a transceiver 264, among other components. Client electronic device 42 may also be provided with a storage device, such as a microdrive or other device, to provide additional storage. Each of the components 226, 204, 216, 262, and 264, may be interconnected using various buses, and several of the components may be mounted on a common motherboard or in other manners as appropriate.

Processor 226 may execute instructions within client electronic device 42, including instructions stored in the memory 204. The processor may be implemented as a chipset of chips that include separate and multiple analog and digital processors. The processor may provide, for example, for coordination of the other components of client electronic device 42, such as control of user interfaces, applications run by client electronic device 42, and wireless communication by client electronic device 42.

In some embodiments, processor 226 may communicate with a user through control interface 258 and display interface 260 coupled to a display 216. The display 216 may be, for example, a TFT LCD (Thin-Film-Transistor Liquid Crystal Display) or an OLED (Organic Light Emitting Diode) display, or other appropriate display technology. The display interface 260 may comprise appropriate circuitry for driving the display 216 to present graphical and other information to a user. The control interface 258 may receive commands from a user and convert them for submission to the processor 226. In addition, an external interface 262 may be provide in communication with processor 226, so as to enable near area communication of client electronic device 42 with other devices. External interface 262 may provide, for example, for wired communication in some implementations, or for wireless communication in other implementations, and multiple interfaces may also be used.

In some embodiments, memory 204 may store information within the client electronic device 42. The memory 204 can be implemented as one or more of a computer-readable medium or media, a volatile memory unit or units, or a non-volatile memory unit or units. Expansion memory 264 may also be provided and connected to client electronic device 42 through expansion interface 266, which may include, for example, a SIMM (Single In Line Memory Module) card interface. Such expansion memory 264 may provide extra storage space for client electronic device 42, or may also store applications or other information for client electronic device 42. Specifically, expansion memory 264 may include instructions to carry out or supplement the processes described above, and may include secure information also. Thus, for example, expansion memory 264 may be provide as a security module for client electronic device 42, and may be programmed with instructions that permit secure use of client electronic device 42. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product may contain instructions that, when executed, perform one or more methods, such as those described above. The information carrier may be a computer- or machine-readable medium, such as the memory 204, expansion memory 264, memory on processor 226, or a propagated signal that may be received, for example, over transceiver 264 or external interface 262.

Client electronic device 42 may communicate wirelessly through communication interface 262, which may include digital signal processing circuitry where necessary. Communication interface 262 may provide for communications under various modes or protocols, such as GSM voice calls, SMS, EMS, or MMS speech recognition, CDMA, TDMA, PDC, WCDMA, CDMA2000, or GPRS, among others. Such communication may occur, for example, through radio-frequency transceiver 264. In addition, short-range communication may occur, such as using a Bluetooth, WiFi, or other such transceiver (not shown). In addition, GPS (Global Positioning System) receiver module 268 may provide additional navigation and location-related wireless data to client electronic device 42, which may be used as appropriate by applications running on client electronic device 42.

Client electronic device 42 may also communicate audibly using audio codec 270, which may receive spoken information from a user and convert it to usable digital information. Audio codec 270 may likewise generate audible sound for a user, such as through a speaker, e.g., in a handset of client electronic device 42. Such sound may include sound from voice telephone calls, may include recorded sound (e.g., voice messages, music files, etc.) and may also include sound generated by applications operating on client electronic device 42.

Client electronic device 42 may be implemented in a number of different forms, as shown in the figure. For example, it may be implemented as a cellular telephone 280. It may also be implemented as part of a smartphone 282, personal digital assistant, remote control, or other similar mobile device.

As discussed above, in the development of conversational agents, significant time and resources are often required to select responses to conversational phrases. For example, a business may utilize a conversational agent to address certain customer service needs. A conversational agent may be developed to receive input dialogue from users to generate certain responses and functionality. As will be discussed in greater detail below, prediction process 10 may at least help, e.g., improve response prediction technology necessarily rooted in computer technology in order to overcome an example and non-limiting problem specifically arising in the realm of computer network communication associated with, e.g., the development of conversational agents. It will be appreciated that the computer processes described throughout are not considered to be well-understood, routine, and conventional functions.

The Prediction Process:

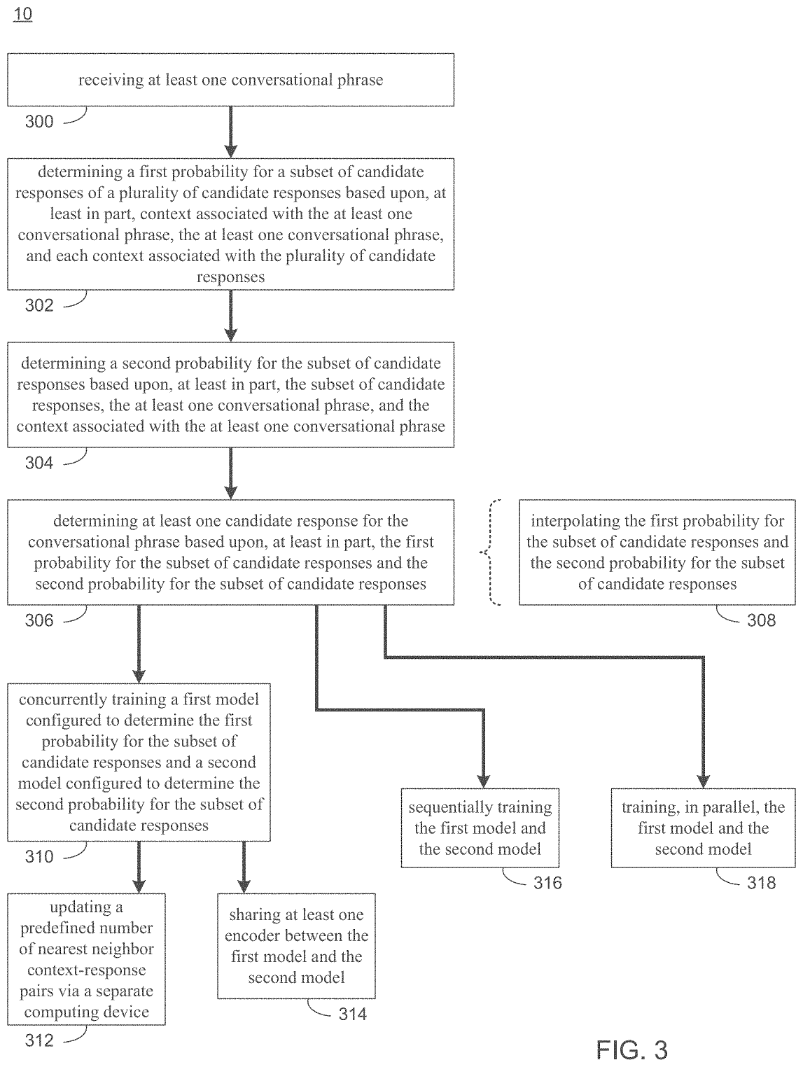

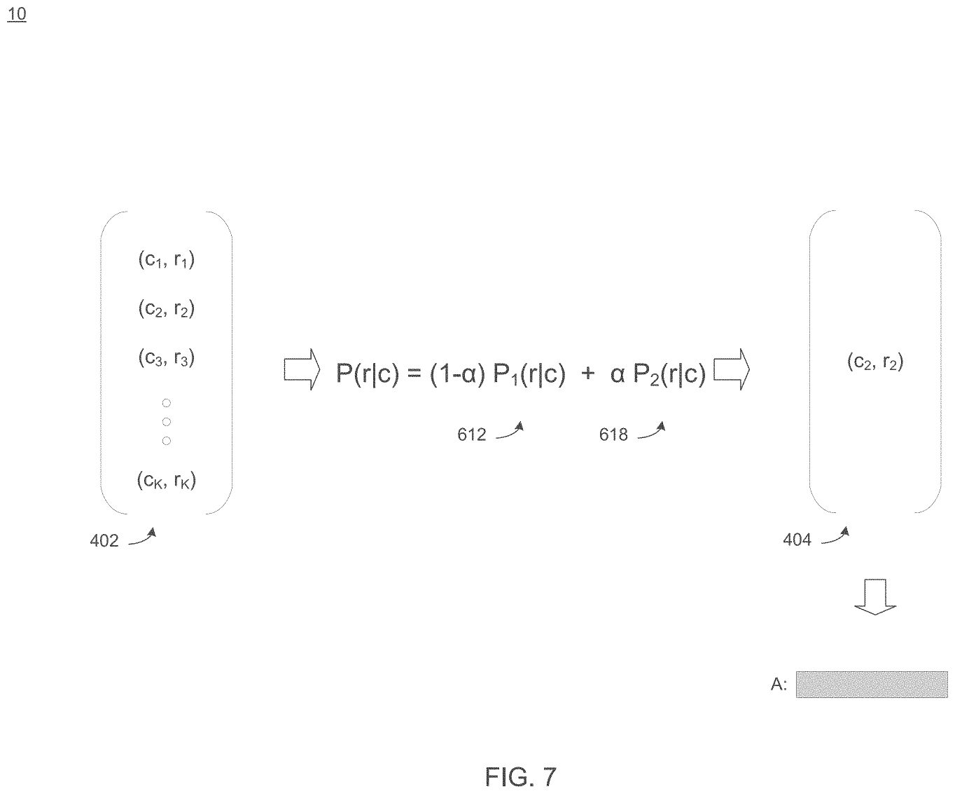

As discussed above and referring also at least to the example implementations of FIGS. 3-7, prediction process 10 may receive 300 at least one conversational phrase. A first probability for a subset of candidate responses of a plurality of candidate responses may be determined 302 based upon, at least in part, context associated with the at least one conversational phrase and each context associated with the plurality of candidate responses. A second probability for the subset of candidate responses may be determined 304 based upon, at least in part, the subset of candidate responses, the at least one conversational phrase, and the context associated with the at least one conversational phrase. At least one candidate response for the conversational phrase may be determined 306 based upon, at least in part, the first probability for the subset of candidate responses and the second probability for the subset of candidate responses.

In some implementations consistent with the present disclosure, systems and methods may be provided for training models for generating responses to conversational phrases for conversational agents. In the development of conversational agents/virtual assistants, significant time and resources are often required to develop dialogue for conversational agents. For example, a business may utilize a conversational agent to address certain customer service needs. A conversational agent may be developed to receive input dialogue from users to generate certain responses and functionality. As will be discussed in greater detail below, prediction process 10 may generate responses for conversational phrases in a dialogue by retrieving and providing candidate responses to a conversational agent from a conversation data corpus based upon, at least in part, the combination of a first probability and a second probability determined for each candidate response. In this manner, prediction process 10 may improve the accuracy in the determination of responses over conventional response prediction approaches by retrieving subsets of candidate responses based on the first probability and the second probability.

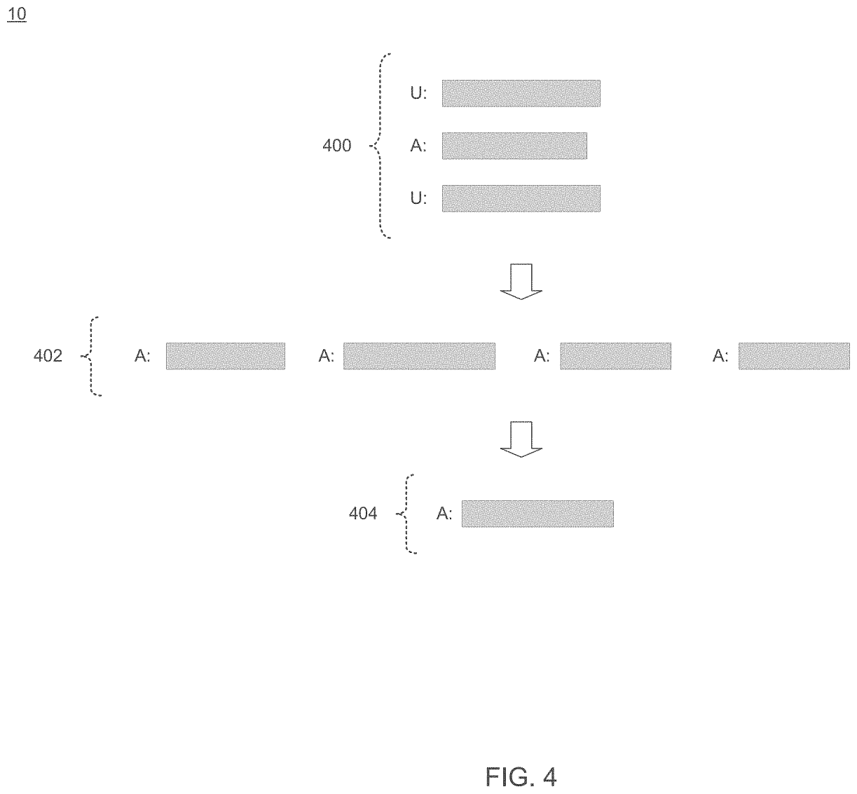

For example and referring also to FIG. 4, prediction process 10 may receive 300 at least one conversational phrase (e.g., at least one conversational phrase 400). A first probability for a subset of candidate responses (e.g., subset of candidate responses 402) of a plurality of candidate responses may be determined 302 based upon, at least in part, context associated with the at least one conversational phrase (e.g., conversational phrase 400), the at least one conversational phrase, and each context associated with the plurality of candidate responses. A second probability for the subset of candidate responses (e.g., subset of candidate responses 402) may be determined 304 based upon, at least in part, the subset of candidate responses (e.g., subset of candidate responses 402), the at least one conversational phrase (e.g., at least one conversational phrase 400), and the context associated with the at least one conversational phrase. At least one candidate response (e.g., at least one candidate response 404) for the conversational phrase may be determined 306 based upon, at least in part, the first probability for the subset of candidate responses (e.g., subset of candidate responses 402) and the second probability for the subset of candidate responses. As will be discussed in greater detail below, the at least one candidate response for the conversational phrase (e.g., at least one candidate response 404) may include a ranking of a predefined number of candidate responses for the at least one conversational phrase (e.g., at least one conversational phrase 400).

In some implementations, prediction process 10 may receive 300, via a computing device, at least one conversational phrase. A conversational phrase (e.g., at least one conversational phrase 400) may generally include at least a portion of text-based conversation data. For example, a conversational agent (e.g., virtual assistant or “chatbot”) may be utilized to provide customer assistance to the extent the conversational agent is trained to understand and respond to user utterances. In some implementations, conversation data may be received by prediction process 10 from recorded conversations between multiple humans (e.g., a human customer and a human customer service agent). In some implementations, the at least one conversational phrase may include a portion of an utterance, a single utterance, and/or multiple utterances. While examples of conversation data between a customer and a customer service agent have been described, it will be appreciated that other conversation data between any number of individuals may be received within the scope of the present disclosure.

In some implementations, receiving 300 the at least one conversational phrase may include receiving at least a portion of a chat transcript and/or converting one or more spoken utterances into one or more text-based representations of the one or more conversations. For example, conversation data received by prediction process 10 may include multi-party chat transcripts or chat logs. In some implementations, conversation data may be received from an audio recording system configured to obtain audio recordings of one or more conversations between a plurality of individuals (e.g. a dialogue) using a microphone or other sound recording device(s).

In some implementations, prediction process 10 may convert the one or more audio recordings of one or more conversations into text-based logs or transcripts. In some implementations, dialogue graph generation process 10 may utilize a transcription engine (e.g., transcription engine 64) to convert audio recordings into transcripts or logs representative of the conversation data. An example of a transcript engine may include, but is not limited to, the Nuance® Transcription Engine produced by Nuance Communications, Inc. However, it will be appreciated that any transcription engine may be used within the scope of the present disclosure.

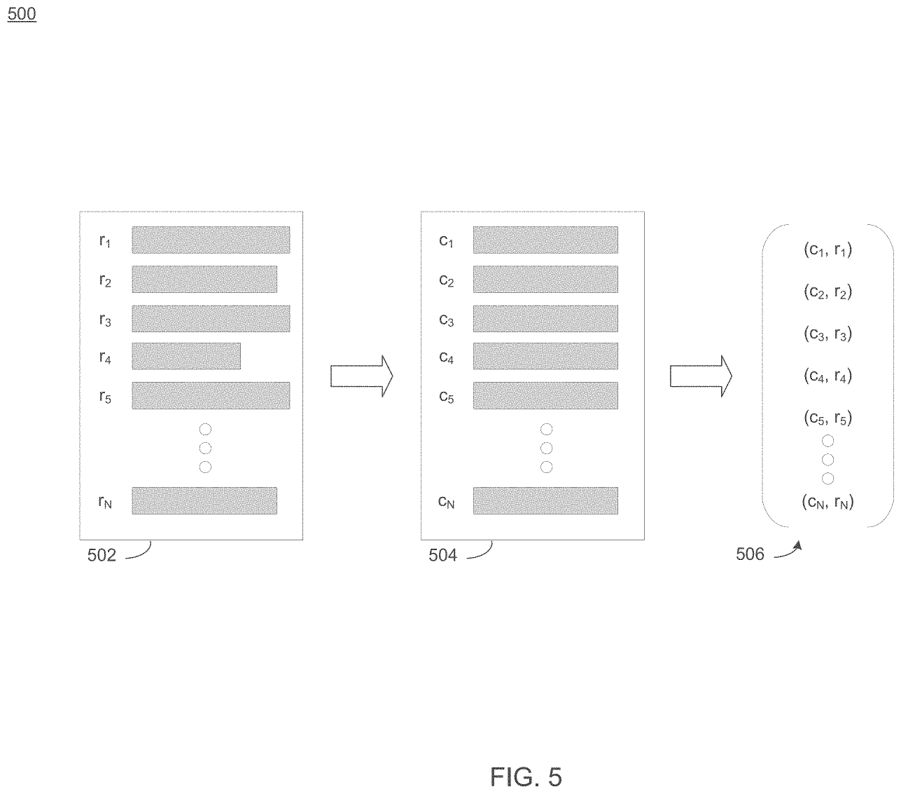

In some implementations, prediction process 10 may determine 302 a first probability for a subset of candidate responses of a plurality of candidate responses based upon, at least in part, context associated with the conversational phrase and each context associated with the plurality of candidate responses. Referring also to the example of FIG. 5, prediction process 10 may maintain and/or have access (e.g., via a network connection as shown in FIG. 1) to a data structure including conversation data. In some implementations, the data structure of conversation data (e.g., conversation database 500) may include a plurality of conversational phrases used in various chat logs and/or transcripts. In some implementations and as will be discussed in greater detail below, prediction process 10 may improve a computing device's and/or dialogue system's ability to generate responses for conversational agents by retrieving previously observed and curated responses from the data structure of conversation data (e.g., conversation database 500).

Referring again to the example of FIG. 5, the data structure of conversation data (e.g., conversation database 500) may include a plurality of conversational phrases that may be used as candidate responses (e.g., plurality of candidate responses 502) to an input conversational phrase (e.g., conversational phrase 400). In some implementations, the plurality of candidate responses (e.g., plurality of candidate responses 502) may be associated with a plurality of contexts (e.g., plurality of contexts 504). In some implementations, the plurality of contexts (e.g., plurality of contexts 504) may be pre-associated with the plurality of candidate responses (e.g., plurality of candidate responses 502) to form a plurality of context-response pairs (e.g., plurality of context-response pairs 506 (e.g., (c₁, r₁); (c₂, r₂); (c₃, r₃); (c₄, r₄); (c₅, r₅); and (c_{N}, r_{N}))). While “N” context-response pairs are shown, it will be appreciated that any number of context-response pairs may be used within the scope of the present disclosure.

In some implementations, the plurality of context-response pairs (e.g., plurality of context-response pairs 506) may constitute training data (i.e., (cᵢ, rᵢ) and i=1, N) for determining 302 the first probability for the subset of candidate responses of the plurality of candidate responses. It will be appreciated that while a particular context-response pair (e.g., (cᵢ, rᵢ)) may appear multiple times in conversation database 500, prediction process 10 may not compress them (i.e., where each pair of cᵢ, rᵢ would only appear once).

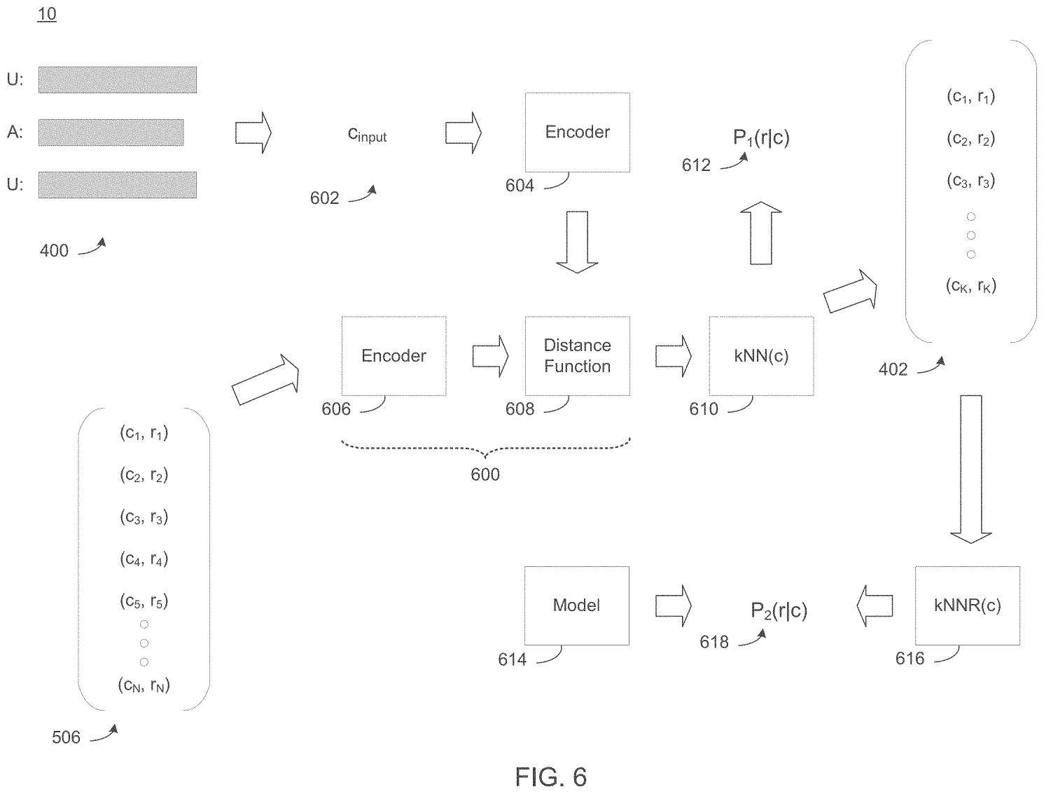

Referring also to the example of FIG. 6 and in some implementations, prediction process 10 may determine 302 a first probability for a subset of candidate responses (e.g., subset of candidate responses 402) of a plurality of candidate responses (e.g., plurality of candidate responses 506) based upon, at least in part, context associated with the at least one conversational phrase, the at least one conversational phrase, and each context associated with the plurality of candidate responses. For example, context for a conversational phrase may generally include any preceding conversation data (e.g., all conversational phrases up to the response to be determined, any metadata, information associated with an agent (e.g., an agent identification, an agent group identification, a business unit identification), and time-related information (e.g., date and/or time of conversation). In some implementations, the context for a portion of conversation data may be determined by extracting at least a portion of the text from the at least one conversational phrase (e.g., all conversational phrases up to the agent response to be determined). For example, suppose a user (e.g., user 46) was working with an agent to determine information associated with e.g., the user's bank account. Suppose the user asks “Can I check the balance of my checking account?” In this example and in some implementations, the context (e.g., context 602) may be the entirety of the user's question (i.e., “Can I check the balance of my checking account?”) and any preceding conversation data (e.g., all conversational phrases up to the agent response to be determined, any metadata, information associated with the agent (e.g., agent identification, agent group identification, business unit identification), and time-related information (e.g., date and/or time of conversation). As will be discussed in greater detail below, the candidate responses may include various responses to the user's question.

While an example of context including the entirety of a user's question has been provided, it will be appreciated that the context may include a portion of an unfinished or incomplete conversational phrase. For example, suppose a user (e.g., user 46) states “Can I check the balance of my . . . ?” In this example, the candidate responses may include suggestions to complete the user's question (e.g., “Did you want to check your bank account?” or “bank account?”). In this manner, prediction process 10 may receive context in the form of an incomplete conversational phrase and may provide candidate responses to complete the conversational phrase. While examples of context have been discussed above, it will be appreciated that any conversation data may be considered context within the scope of the present disclosure.

Referring again to the example of FIG. 6, prediction process 10 may utilize a model (e.g., first model 600) to determine 302 the first probability for a subset of candidate responses of a plurality of candidate responses. For example, model 600 may embed context 602 associated with conversational phrase 400, via a deep learning encoder (e.g., encoder 604), to define a vector representation (e.g., embed(c)) of context 602. Examples of encoder 604 may generally include a bi-directional Long Short Term Memory (LSTM) network, a convolutional neural network (CNN), a transformer, etc. While examples of encoder 604 have been discussed, it will be appreciated that the selection and/or configuration of encoder 604 and/or other encoder-related parameters may be optimized for accuracy, latency requirements, etc. within the scope of the present disclosure.

Prediction process 10 may embed the plurality of contexts 606 associated with the plurality of candidate responses 506 using a deep learning encoder (e.g., encoder 606) to define a vector representation of plurality of contexts (e.g., embed(cᵢ), where i=is the number of context-response pairs in the plurality of context-response pairs 506). In some implementations and as will be discussed in greater detail below, encoder 606 may be a neural context encoder with explicit memorization of training (context, response) pairs (e.g., context-response pairs 506). While encoder 606 is shown as a separate encoder from encoder 604, it will be appreciated that in some implementations, the same encoder may be used to embed context 602 and the plurality of contexts into respective vector representations (e.g., embed(c) and embed(cᵢ)). In this manner, prediction process 10 may define vector representations within the same embedding space to allow the similarity/distance between context 602 and the plurality of contexts to be determined.

As shown in FIG. 6, model 600 may, via a distance/similarity function (e.g., distance function 608) determine a distance between the context associated with the conversational phrase (e.g., context 602) and the at least one conversational phrase (e.g., at least one conversational phrase 400), and the plurality of contexts (e.g., plurality of contexts) associated with each context-response pair of the plurality of context-response pairs (e.g., plurality of context-response pairs 506). In some implementations, d(c, cᵢ) may denote the distance of the two contexts in the embedding space (i.e., d(c, cᵢ)=distance(embed(c), embed(cᵢ)). Examples of distance function 608 may include cosine distance functions, Euclidean distance functions, etc. As such, it will be appreciated that any distance function may be used within the scope of the present disclosure.

In some implementations, while prediction process 10 could sort all the (cᵢ, rᵢ) based on d(c,cᵢ) and take the “k” smallest (c₁, rᵢ), prediction process 10 may utilize the k “nearest neighbors” or “kNN” (kNN(c) 610) to determine the “k” nearest (cᵢ, rᵢ) pairs according to d (c,cᵢ), where “k” is a predefined value. For example, with large training data (i.e., N is large), a fast approximate kNN(c) search can be applied by prediction process 10 to reduce search overhead and computing resources required to determine 302 the first probability for the subset of candidate responses.

In some implementations, the subset of candidate responses of the plurality of candidate responses may include a predefined number of nearest neighbor context-response pairs of a plurality of context-responses pairs. Referring again to the example of FIG. 6, prediction process 10 may, via the combination of distance function 608 and kNN(c) 610, determine a predefined number (i.e., “k”) nearest neighbor context-response pairs. In this example, prediction process 10 may determine that subset of candidate responses 402 includes context-response pairs (c₁, r₁); (c₂, r₂); (c₃, r₃); and (c_{K}, r_{K}). It will be appreciated that subset of candidate responses 402 may include at least “k” candidate responses. Accordingly, the subset of candidate responses may also be referred to as a subset of candidate context-response pairs (e.g., subset of candidate context-response pairs 402).

In some implementations, the first probability (e.g., first probability 612) may define a likelihood of the subset of candidate responses (e.g., subset of candidate responses 402) as candidate responses to the at least one conversational phrase (e.g., conversational phrase 400) based upon, at least in part, a distance between the context of the at least one conversational phrase and the context associated with each context-response pair observed in system training. For example, prediction process 10 may leverage memorization of the training corpus (i.e., plurality of context-response pairs 506) to determine the first probability (e.g., first probability 612). That is, prediction process 10 may combine a neural context encoder with explicit memorization of training (context, response) pairs (e.g., encoder 606), and utilize the encoder to determine and induce a probability distribution over nearest contexts and thus (subsequent) responses. In this manner, the first probability (e.g., first probability 612) may be a “context-to-context” probability (i.e., probability based on distance between the context of the conversational phrase and the context associated with each context-response pair observed in system training). For example, the context-to-context probability may be defined as shown below in Equation 1:

$${p}_{1} ( r \vert c ) = \frac{{\sum }_{( {c}_{i} , {r}_{i} ) ∈ kNN ( c )} {e}^{d ( c , {c}_{i} )} δ ( r , {r}_{i} )}{{\sum }_{( {c}_{i} , {r}_{i} ) ∈ kNN ( c )} {e}^{d ( c , {c}_{i} )}} \qquad ( 1 )$$

where δ(r, rᵢ)=1 if r==rᵢ and else 0

As shown above in Equation 1, the first probability (e.g., first probability 612) may define the likelihood of a conversational agent response “r” given conversational phrase context “c”, based on associated contexts computed as the distance-weighted relative frequency of a response among the nearest observed contexts. In this manner, the first probability (e.g., first probability 612) may score the subset of candidate responses based on similarity of current context to those observed in training, and their immediately subsequent or adjacent responses.

In some implementations, prediction process 10 may determine 304 a second probability for the subset of candidate responses based upon, at least in part, the subset of candidate responses, the at least one conversational phrase, and the context associated with the at least one conversational phrase. Referring again to the example of FIG. 6, prediction process 10 may utilize a model (e.g., second model 614) to determine the second probability for the subset of candidate responses. For example, model 614 may, via a deep learning encoder (e.g., encoder 604), embed context 602 associated with conversational phrase 400 to define a vector representation (e.g., embed(c) 606) of context 602. Prediction process 10 may embed each of the candidate responses of the subset of candidate responses associated with the subset of candidate context-responses pairs (e.g., subset of candidate context-response pairs 402) using a deep learning encoder to define a vector representation of a pair of context “c” and candidate response “r” (e.g., embed(c, r)). In some implementations, an encoder of model 614 may embed the context “c” and the candidate response “r” independently (i.e., context encoders and response encoders do not share any parameter) or jointly (i.e., context encoders and response encoders share common parameters).

In some implementations, prediction process 10 may, via a distance/similarity function of model 614 determine a distance between the context associated with the conversational phrase (e.g., context 602) and the at least one conversational phrase (e.g., at least one conversational phrase 400), and the plurality of responses associated with each context-response pair of the subset of context-response pairs (e.g., subset of context-response pairs 402). For example, d(c, r) may denote the distance computed based on embed(c, r). Examples of distance function of model 614 may include cosine distance functions, Euclidean distance functions, etc. As such, it will be appreciated that any distance function may be used within the scope of the present disclosure.

In some implementations, prediction process 10 may utilize the k “nearest neighbors” or “kNNR” (kNNR(c) 616) to determine the “k” nearest unique responses from the subset of candidate responses (e.g., subset of candidate responses 402), where kNNR refers to the set of unique responses immediately subsequent or adjacent to the contexts in kNN(c). As shown in FIG. 6 and in some implementations, kNNR(c) 616 may be directly derived from kNN(c).

In some implementations, the second probability (e.g., second probability 712) may define a likelihood of the subset of candidate responses (e.g., subset of candidate responses 402) as candidate responses to the at least one conversational phrase (e.g., conversational phrase 400) based upon, at least in part, a distance between the context of the conversational phrase and the at least one conversational phrase, and the response associated with each context-response pair of the subset of candidate responses. For example, prediction process 10 may directly model a probability distribution over the subset of candidate responses via a context/response encoder. In this manner, the second probability may be a “context-to-response” probability (i.e., a probability based upon a distance between the context of the conversational phrase and the response associated with each context-response pair of the subset of candidate responses). For example, the context-to-response probability may be defined as shown below in Equation 2:

$${p}_{2} ( r \vert c ) = \frac{{e}^{d ( c , r )}}{{\sum }_{{r}_{i} ∈ kNNR ( c )} {e}^{d ( c , {r}_{i} )}} \qquad ( 2 )$$

As shown above in Equation 2, the second probability may define the likelihood of a candidate response “r” given context “c”, based upon the context-response similarity/distance (i.e., d(c, r)).

In some implementations, prediction process 10 may determine 306 at least one candidate response for the conversational phrase based upon, at least in part, the first probability for the subset of candidate responses and the second probability for the subset of candidate responses. Referring also to the example of FIG. 8 and in some implementations, prediction process 10 may determine at least one candidate response (e.g., at least one candidate response 404) for the conversational phrase (e.g., conversational phrase 400) based upon, at least in part, the first probability (e.g., first probability 612) for the subset of candidate responses and the second probability (e.g., second probability 618) for the subset of candidate responses. In some implementations, the at least one candidate response (e.g., at least one candidate response 404) may be a ranked list including a predefined number of candidate responses.

Prediction process 10 may determine 306 the at least one candidate response for a conversational agent (e.g., collaboration application 20 and/or computing device 12 executing a conversational agent) for use in a dialogue. In some implementations, prediction process 10 may determine 306 and/or provide the at least one candidate response (e.g., at least one candidate response 404) to a user (e.g., user 46) for selection when responding in a dialogue with at least one other user.

In some implementations, determining 306 the at least one candidate response to the conversational phrase based upon, at least in part, the first probability for the subset of candidate responses and the second probability for the subset of candidate responses may include interpolating 308 the first probability for the subset of candidate responses and the second probability for the subset of candidate responses. For example, interpolating the first probability for the subset of candidate responses and the second probability for subset of candidate responses may include weighting the contribution of one probability over the other probability. In this manner, the subset of responses candidates from the first retrieval may be scored by the second model and the scores may be fused/interpolated. For example, the probability for a candidate response, r, given the context, c, associated with the conversational phrase may be defined as shown below in Equation 3:

p(r|c)=α·p₁(r|c)+(1−α)·p₂(r|c) (3)

As discussed above, the weight for either the first probability or the second probability may be defined by a. While one example of interpolating the first probability for the subset of candidate responses and the second probability for the subset of candidate responses has been provided, it will be appreciated that the first probability for the subset of candidate responses and the second probability for the subset of candidate responses may be interpolated in various ways within the scope of the present disclosure.

In some implementations, the first probability and the second probability may both provide probability distributions over responses and given that they form their estimates in different ways (i.e., the first probability combines a neural context encoder with direct memorization of responses observed with closest training contexts while the second probability directly models a distribution over responses via a neural context/response encoder), prediction process 10 may benefit from an ensembling effect via interpolating the first probability and the second probability to determine at least one candidate response for the at least one conversational phrase.

In some implementations, the present disclosure may provide accuracy at viable speed for a computing device and various models (e.g., combinations of encodes and distance functions) generating or retrieving candidate responses to a given input context. In particular, utilizing the first probability to select (via trained neural encoding plus memorization) and score a subset of candidate responses (based on similarity of current context to those observed in training, and their immediately subsequent responses) followed by fusing/interpolating the scores from the second probability to re-rank those candidates provides superior accuracy to using conventional prediction processes to rank candidates. In one example, the accuracy (measured by the percentage of contexts where the suggested top-1 responses exactly match the observed response) over three example data sets, when using conventional approaches, was only 25.3% and, when interpolating the first and second probabilities according to implementations of the present disclosure, was 30.8%; resulting in a 5.5% improvement. Accordingly, the ability for a computing device to accurately retrieve a candidate response to a given context, may be improved.

In some implementations, prediction process 10 may train one or more models to maximize the likelihood of an observed agent response given a particular context over a corpus of observed context-response pairs. As discussed above, a model may generally include a machine learning process including various neural networks. For example and as discussed above, model 600 may include various encoders and distance functions configured to determine 302 the first probability for a subset of candidate responses of a plurality of candidate responses and model 700 may include various encoders and distance functions configured to determine 304 the second probability for the subset of candidate responses. Accordingly, the combination of models 600 and 614 may be utilized by prediction process 10 to provide 306 the at least one candidate response to the conversational phrase based upon, at least in part, the first probability for the subset of candidate responses and the second probability for the subset of candidate responses. In this manner, a combination of one or more models (e.g., models 600 and 614) may be considered to be a combination of sub-models of a model for providing at least one candidate response for the conversational phrase. In some implementations, various portions of the one or more models (e.g., models 600 and 614) may be modified to maximize the likelihood of an observed agent response given a particular context over a corpus of observed context-response pairs. For example, prediction process 10 may train one or more models, parameterized by θ, as shown below in Equation 4:

θ*=argmax_{θ}p(r|c,θ) (4)

In some implementations and as shown above in Equation 4, r and c may be vectors of length |corpus| such that (c[i],r[i] indicates that r[i] was observed to immediately follow dialog context c[i]. In some implementations, these events may be treated as independent and, as such, the probability decomposes as a product as shown below in Equation 5:

p(r[i]|c[i])=p(r[1]|c[1])*p(r[2]|c[2])* . . . p(r[|corpus|]|c[|corpus|]) (5)

Accordingly, Equation 4 may be formulated as shown below in Equation 6, yielding the equivalence of maximum likelihood and minimizing entropy loss:

θ*=argmax_{θ}(−Σᵢ₌₁^{|corpus|}log(p(r[i]|c[i]))) (6)

In some implementations, prediction process 10 may concurrently train 310 a first model configured to determine the first probability for the subset of candidate responses and a second model configured to determine the second probability for the subset of candidate responses, together. For example and as shown in Equation 2, in the process of estimating the probability of the observed response r given the context c, the denominator is a summation based on kNN(c), the k most similar contexts retrieved based on the distance between c and the contexts under consideration. Therefore, kNN(c) may not be a constant, but a dynamic set based on the model parameters in computing d(c, cᵢ). Accordingly, a standard batch-based training process may be outlined as follows:
1. Initialize model θ (e.g., randomize θ)
2. For batch bᵢ of training examples
3. Update kNN(c) for context c in batch bᵢ//update kNN(c) based on new/current θ
4. θ=Optimize(θ, bᵢ)//update the model based on derivatives computed from bᵢ

In this manner, prediction process 10 may optimizing one or more parameters associated with the first probability (e.g., first probability 612) on a first model (e.g., model 600), one or more parameters associated with the second probability (e.g., second probability 618) on a second model (e.g. model 614), and the weighting factor (e.g., a) all at the same time. However, the training process above may be too slow for any realistic training data (e.g., >100K turns) because efficient computation of kNN( ) may require precomputing context encodings for the full train set. Accordingly, prediction process 10 may utilize one or more alternative faster training algorithms with different levels of approximation. For example, one alternative training algorithm may simply reduce the frequency of computing kNN(c) from once per mini-batch to once every “U” mini-batches. In some implementations, “U” may be a configurable number. This process may be outlined as follows:
1. Initialize model θ (e.g., randomize θ)
2. For batch bᵢ of training examples:
3. θ=Optimize(θ, bᵢ)//update the model based on derivatives computed from bᵢ
4. if i % U==0//update every U batches
5. Update kNN(c) for all the context c in the training data

In some implementations, concurrently training 310 the first model and the second model together may include updating 312 a predefined number of nearest neighbor context-response pairs via a separate computing device. In the above example, the process of updating the context encodings and data structure to support efficient kNN calculation may be executed on separate computing devices or resources such that the optimization of other model weights (e.g., non-kNN optimizations) may be executed concurrently (e.g., concurrently train 310 the first model and the second model together).

In some implementations, concurrently training 310 the first model and the second model together may include sharing 314 at least one encoder between the first model and the second model. For example, where the first model (i.e., the model configured to determine the first probability) and the second model (i.e., the model configured to determine the second probability) are jointly or concurrently trained 310 together, each model may utilize a shared encoder. In this manner, the number of parameters for training and/or optimizing each model may be significantly reduced.

In some implementations, prediction process 10 may sequentially train 316 the first model and the second model. For example and in some implementations, a first model (e.g., model 600) configured to determine 302 the first probability may be independent of the second model (e.g., model 614) configured to determine 304 the second probability. The first model may be trained first (i.e., before the second model) and used to generate kNN(c) which may be “fed” to the training process of the second model. Accordingly, prediction process 10 may sequentially train 316 the first model and the second model. This sequential training process may be outlined as follows:
1. Train the first model (e.g., encoder and/or distance function parameterized by θₚ₁) with randomly sampled contexts which are not followed by r as shown in Equation 7.

θₚ₁*=argmax_{θ}_{ₚ₁}p₁(r|c,θₚ₁) (7)
2. Use the context encoder from action 1 to generate kNN search results for all the context in the training data. Note that this may only need to be computed once and then kept static throughout the training of the second model below.
3. Train the second model (e.g., encoder and/or distance function parameterized by θₚ₂) with frozen θₚ₁ and frozen context retrieved from action 2 as shown in Equation 8:

θₚ₂*=argmax_{θ}_{ₚ₂}p(r|c,θₚ₂,θₚ₁) (8)

In some implementations, prediction process 10 may train 318, in parallel, the first model and the second model. For example, if the kNN retrieved context used in training the second model is further approximated to a set of randomly picked contexts which are not followed by the target response, prediction process 10 may completely de-couple the training of the first model and the second model. Accordingly, prediction process 10 may train both models in parallel as outlined below:
1. Train the first model (e.g., encoder and/or distance function parameterized by θₚ₁) with randomly sampled contexts which are not followed by r as shown in Equation 9.

θₚ₁*=argmax_{θ}_{ₚ₁}p₁(r|c,θₚ₁) (9)
2. In parallel with action 1, train the second model (e.g., encoder and/or distance function parameterized by θₚ₂) with randomly sampled contexts which are not followed by r as shown below in Equation 10:

θₚ₂*=argmax_{θ}_{ₚ₂}p₂(r|c,θₚ₂) (10)
3. The parameter a controlling the contribution or weight of the first probability and the second probability may be considered as a hyper parameter and tuned based on some held out validation data.

In some implementations, if the context encoder trained in the second model is used for relevant context retrieval at run time, a very simple training algorithm is possible, as follows:
1. Train the second model (e.g., encoder and/or distance function parameterized by θₚ₂) with randomly sampled contexts which are not followed by r as shown below in Equation 11:

θₚ₂*=argmax_{θ}_{ₚ₂}p₂(r|c,θₚ₂) (11)
2. Re-use the second model's encoder and/or distance function for retrieving relevant contexts for the given input context in run time, and the parameter a controlling the contribution of the first probability and second probability may be considered as a hyper parameter and tuned based on some held out validation data.

It will be appreciated that while prediction process 10 is described as training the first model and the second model, a separate training process associated with prediction process 10 may actually train the first model and/or the second model. That is, in some implementations, prediction process 10 may be associated with a separate training process used to train the first model and/or the second model, and in some implementations, prediction process 10 may include its own training process. As such, the description of prediction process 10 training the model should be taken as example only, and not to otherwise limit the scope of the disclosure.

In some implementations, the present disclosure may be utilized as voice-to-voice chats, implemented as Automated Speech Recognition (ASR) to text, where prediction process 10 may process the chats as text, and utilize Text to Speech (TTS) for the results. That is, the present disclosure may be extended to speech-to-speech by, e.g., applying an ASR portion of prediction process 10 to the input speech and TTS to typed agent responses. As such, the description of using a strictly text-based approach should be taken as example only and not to otherwise limit the scope of the present disclosure. Similarly, in some implementations, prediction process 10 may train the text-based model from the inputs of the audio chats, by transcribing the result to text, and using the result as training data.

The terminology used herein is for the purpose of describing particular implementations only and is not intended to be limiting of the disclosure. As used herein, the singular forms “a”, “an” and “the” are intended to include the plural forms as well, unless the context clearly indicates otherwise. As used herein, the language “at least one of A, B, and C” (and the like) should be interpreted as covering only A, only B, only C, or any combination of the three, unless the context clearly indicates otherwise. It will be further understood that the terms “comprises” and/or “comprising,” when used in this specification, specify the presence of stated features, integers, steps (not necessarily in a particular order), operations, elements, and/or components, but do not preclude the presence or addition of one or more other features, integers, steps (not necessarily in a particular order), operations, elements, components, and/or groups thereof.

The corresponding structures, materials, acts, and equivalents (e.g., of all means or step plus function elements) that may be in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications, variations, substitutions, and any combinations thereof will be apparent to those of ordinary skill in the art without departing from the scope and spirit of the disclosure. The implementation(s) were chosen and described in order to explain the principles of the disclosure and the practical application, and to enable others of ordinary skill in the art to understand the disclosure for various implementation(s) with various modifications and/or any combinations of implementation(s) as are suited to the particular use contemplated.

Having thus described the disclosure of the present application in detail and by reference to implementation(s) thereof, it will be apparent that modifications, variations, and any combinations of implementation(s) (including any modifications, variations, substitutions, and combinations thereof) are possible without departing from the scope of the disclosure defined in the appended claims.

What is claimed is:

1. A computer-implemented method, executed on a computing device, comprising:
receiving, via a computing device, at least one conversational phrase;
determining a first probability for a subset of candidate responses of a plurality of candidate responses based upon, at least in part, context associated with the at least one conversational phrase, the at least one conversational phrase, and each context associated with the plurality of candidate responses;
determining a second probability for the subset of candidate responses based upon, at least in part, the subset of candidate responses, the at least one conversational phrase, and the context associated with the at least one conversational phrase; and
determining at least one candidate response for the conversational phrase based upon, at least in part, the first probability for the subset of candidate responses and the second probability for the subset of candidate responses.

2. The computer-implemented method of claim 1, wherein the subset of candidate responses of the plurality of candidate responses includes a predefined number of nearest neighbor context-response pairs of a plurality of context-responses pairs observed in system training.

3. The computer-implemented method of claim 2, wherein the first probability defines a likelihood of the subset of candidate responses as candidate responses to the at least one conversational phrase based upon, at least in part, a distance between the context of the at least one conversational phrase and the at least one conversational phrase, and the context associated with each context-response pair observed in system training.

4. The computer-implemented method of claim 2, wherein the second probability defines a likelihood of the subset of candidate responses as candidate responses to the at least one conversational phrase based upon, at least in part, a distance between the context of the conversational phrase and the at least one conversational phrase, and the response associated with each context-response pair of the subset of candidate responses.

5. The computer-implemented method of claim 1, wherein determining the at least one candidate response to the conversational phrase based upon, at least in part, the first probability for the subset of candidate responses and the second probability for the subset of candidate responses includes interpolating the first probability for the subset of candidate responses and the second probability for the subset of candidate responses.

6. The computer-implemented method of claim 1, further comprising one or more of:
concurrently training a first model configured to determine the first probability for the subset of candidate responses and a second model configured to determine the second probability for the subset of candidate responses, together;
sequentially training the first model and the second model; and
training, in parallel, the first model and the second model.

7. The computer-implemented method of claim 6, wherein concurrently training the first model and the second model together includes one or more of:
updating a predefined number of nearest neighbor context-response pairs via a separate computing device; and
sharing at least one encoder between the first model and the second model.

8. A computer program product residing on a non-transitory computer readable medium having a plurality of instructions stored thereon which, when executed by a processor, cause the processor to perform operations comprising:
receiving at least one conversational phrase;
determining a first probability for a subset of candidate responses of a plurality of candidate responses based upon, at least in part, context associated with the at least one conversational phrase, the at least one conversational phrase, and each context associated with the plurality of candidate responses;
determining a second probability for the subset of candidate responses based upon, at least in part, the subset of candidate responses, the at least one conversational phrase, and the context associated with the at least one conversational phrase; and
determining at least one candidate response for the at least one conversational phrase based upon, at least in part, the first probability for the subset of candidate responses and the second probability for the subset of candidate responses.

9. The computer program product of claim 8, wherein the subset of candidate responses of the plurality of candidate responses includes a predefined number of nearest neighbor context-response pairs of a plurality of context-responses pairs observed in system training.

10. The computer program product of claim 9, wherein the first probability defines a likelihood of the subset of candidate responses as candidate responses to the at least one conversational phrase based upon, at least in part, a distance between the context of the at least one conversational phrase and the at least one conversational phrase, and the context associated with each context-response pair observed in system training.

11. The computer program product of claim 9, wherein the second probability defines a likelihood of the subset of candidate responses as candidate responses to the at least one conversational phrase based upon, at least in part, a distance between the context of the at least one conversational phrase and the at least one conversational phrase, and the response associated with each context-response pair of the subset of candidate responses.

12. The computer program product of claim 8, wherein determining the at least one candidate response to the conversational phrase based upon, at least in part, the first probability for the subset of candidate responses and the second probability for the subset of candidate responses includes interpolating the first probability for the subset of candidate responses and the second probability for the subset of candidate responses.

13. The computer program product of claim 8, wherein the operations further comprise one or more of:
concurrently training a first model configured to determine the first probability for the subset of candidate responses and a second model configured to determine the second probability for the subset of candidate responses, together;
sequentially training the first model and the second model; and
training, in parallel, the first model and the second model.

14. The computer program product of claim 13, wherein concurrently training the first model and the second model together includes one or more of:
updating a predefined number of nearest neighbor context-response pairs via a separate computing device; and
sharing at least one encoder between the first model and the second model.

15. A computing system comprising:
a memory; and
a processor configured to receive at least one conversational phrase, wherein the processor is further configured to determine a first probability for a subset of candidate responses of a plurality of candidate responses based upon, at least in part, context associated with the at least one conversational phrase, the at least one conversational phrase, and each context associated with the plurality of candidate responses, wherein the processor is further configured to determine a second probability for the subset of candidate responses based upon, at least in part, the subset of candidate responses, the at least one conversational phrase, and the context associated with the at least one conversational phrase, and wherein the processor is further configured to determine at least one candidate response for the at least one conversational phrase based upon, at least in part, the first probability for the subset of candidate responses and the second probability for the subset of candidate responses.

16. The computing system of claim 15, wherein the subset of candidate responses of the plurality of candidate responses includes a predefined number of nearest neighbor context-response pairs of a plurality of context-responses pairs observed in system training.

17. The computing system of claim 16, wherein the first probability defines a likelihood of the subset of candidate responses as candidate responses to the at least one conversational phrase based upon, at least in part, a distance between the context of the at least one conversational phrase and the at least one conversational phrase, and the context associated with each context-response pair observed in system training.

18. The computing system of claim 16, wherein the second probability defines a likelihood of the subset of candidate responses as candidate responses to the at least one conversational phrase based upon, at least in part, a distance between the context of the at least one conversational phrase and the at least one conversational phrase, and the response associated with each context-response pair of the subset of candidate responses.

19. The computing system of claim 15, wherein determining the at least one candidate response to the at least one conversational phrase based upon, at least in part, the first probability for the subset of candidate responses and the second probability for the subset of candidate responses includes interpolating the first probability for the subset of candidate responses and the second probability for the subset of candidate responses.

20. The computing system of claim 15, wherein the processor is further configured to one or more of:
concurrently train a first model configured to determine the first probability for the subset of candidate responses and a second model configured to determine the second probability for the subset of candidate responses, together;
sequentially train the first model and the second model; and
train, in parallel, the first model and the second model.
